(19) United States
(12) Patent Application Publication
(10) Pub. No.: US 2020/0248081 A1
(43) Pub. Date: Aug. 6, 2020

(54) A DEWAXING AID FOR PETROLEUM REFINING

(71) Applicants: HINDUSTAN PETROLEUM CORPORATION LIMITED, Bangalore (IN); COUNCIL OF SCIENTIFIC & INDUSTRIAL RESEARCH, New Delhi (IN)

(72) Inventors: Chintalapati Siva Kesava Raju, Bangalore (IN); Ganagalla Srinivasa Rao, Bangalore (IN); Kottari Naresh, Bangalore (IN); Gnanasekaran Valavarasu, Bangalore (IN); Peddy Venkata Chalapathi Rao, Bangalore (IN); Nettem Venkateswarlu Choudary, Bangalore (IN); Gandham Sriganesh, Bangalore (IN); Annadanam Venkata Sesha Sainath, Hyderabad (IN); Kothapalli Venkata Suryanaray Raju, Hyderabad (IN); Tammishetti Shekharam, Hyderabad (IN)

(21) Appl. No.: 16/637,446

(22) PCT Filed: Jun. 26, 2018
(86) PCT No.: PCT/IN2018/050420

§ 371 Date: Feb. 7, 2020

(30) Foreign Application Priority Data
Aug. 8, 2017 (IN) 201741028218

(51) Int. Cl. C10G 73/04; C08F 220/68; C08F 220/14; C10G 21/16; C08F 220/18; C10M 173/00; C10M 101/02

(52) U.S. Cl. CPC C10G 73/04; C08F 220/68; C08F 220/14; C10G 21/16; C10N 2070/00; C10M 173/00; C10M 101/02; C10G 2300/1062; C10M 2203/1085; C08F 220/1811

(57) ABSTRACT

The present disclosure relates to a copolymer of Formula I. The copolymer exhibits excellent dewaxing ability for dewaxing of fuels. When used for dewaxing, the resultant dewaxed fuel is substantially free of wax, exhibits better pour point, cloud point, and kinematic viscosity. Moreover, the dewaxing proceeds with very good yields.

### TECHNICAL FIELD

The present disclosure relates to the field of petroleum refining. More particularly, it pertains to a dewaxing aid composition and process of preparing the dewaxing aid composition and evaluation of the dewaxing aids. It further relates to the process of dewaxing the petroleum products.

### BACKGROUND

Most paraffinic crude oils contain a significant amount of wax across the entire lube fraction viscosity range. Since the wax in base oil has a high melting point, as temperatures drop, the wax crystallizes and thickens the lubricant until it finally stops flowing. Therefore, dewaxing processes are used during lube refining to remove waxy components from base oils to ensure that lubricants formulated with these base oils will continue to flow at low temperatures. One of the most common dewaxing processes is solvent dewaxing. In the solvent dewaxing process, the raffinate (a mixture of base oil and wax) is first diluted with a chilled solvent system using either propane or ketone/toluene.

Propane dewaxing is a physical separation process for removal of wax from lube raffinate streams using propane as solvent. It makes use of the fact that propane at low temperatures tends to dissolve the desirable oil components while rejecting the wax. Excess propane is used as an auto-refrigerating agent to cool the oil to low temperatures at which this operation must be conducted. The oil feed is mixed with propane solvent and cooled to desired temperature by auto refrigeration. The unwanted wax crystallizes out of solution and is removed by continuous rotary drum filters so that the oil base stock has the desired low temperature flow characteristics. Solvent is removed from the wax and dewaxed oil and then is sent as final product to storage tanks.

Due to its complexity, the dewaxing of lubricant base oils is the most difficult and costly process in lube manufacturing. The waxy material in lube oil fractions is macrocrystalline (or simply crystalline) and/or microcrystalline, but under certain conditions may behave like a colloid. When the raffinate with solvent is chilled rapidly with moderate stirring, a wax is precipitated that is often difficult to separate by filtration. The conditions under which the wax crystals are grown are among the most important considerations in the dewaxing process. The size and shape of the crystals are affected by the nature of the paraffinic hydrocarbons in the oil, the nature of the precipitating solvents, the speed of chilling, and the agitation during chilling. While less economical, filtration of the precipitated wax can be facilitated by adding more solvent to the solution or reducing the cooling rate. Paraffinic hydrocarbons from heavier lube oil fractions tend to form smaller crystals called microcrystalline wax that trap oil in pockets between crystals, to the detriment of achieving a good separation of wax from the filtrate. Very fine crystals tend to clog the filter media rapidly, reducing the filtration rate and eventually necessitating shutdown of the filters for removal of the accumulated wax. Very large crystals tend to form gel-like interlocking masses which do not form a compact filtered cake, which contain large amounts of oil and solvent, and which are difficult to wash. As a solution to this problem, it has become a practice in the art to incorporate in the wax-containing petroleum oil materials which modify the size and shape of wax crystals, in such a manner as to permit more rapid separation of the wax during dewaxing operations. This modification in the size and shape of the wax crystals is achieved by the use of an appropriate dewaxing aid.

A dewaxing aid is a polymeric material that co-crystallizes with the wax and helps to develop larger, more uniformly sized wax crystals that enable higher filtration rates due to the improved filtrate separation from the agglomerated crystals. An appropriately selected and applied dewaxing aid thereby provides increased throughput, increased dewaxed oil yield, decreased oil in wax for the slack wax, and a decreased rate of filter blinding.

However, the continued need for more efficient petroleum dewaxing processes has raised the requirements of dewaxing and filtering aids. The provision of new and more efficient dewaxing aids is, therefore, of great importance to the petroleum refining art.

### SUMMARY

The present disclosure relates to a copolymer of Formula I,

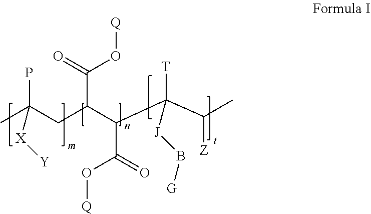

wherein ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH; ‘m’, ‘n’, and ‘t’ are in the range of 2-500.

The present disclosure also relates to a process of the preparation of the copolymer of Formula I.

The present disclosure further relates to a process for dewaxing petroleum product, comprising the steps of: (a) contacting at least one solvent, and at least one polymer as described herein to obtain a first mixture; (b) contacting the first mixture, and at least one petroleum product, to obtain the second mixture; (c) filtering the second mixture through a filtering assembly to obtain a residue and a filtrate; (d) washing the residue and the filtrate with at least one solvent to obtain a washed residue and a filtrate with wash; and (e) processing the washed residue and filtrate with wash to obtain the dewaxed petroleum product.

These and other features, aspects and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates the (a) TGA curves of synthesized dewaxing aid copolymers (P1-P8).

FIG. 2 depicts TGA curves of 5 L scaled up batch dewaxing aid copolymers (P9 and P10), in an accordance with an embodiment of the present disclosure.

FIGS. 3a and 3b illustrate the representative DSC thermograms of dewaxing aid copolymers, in an accordance with an embodiment of the present disclosure.

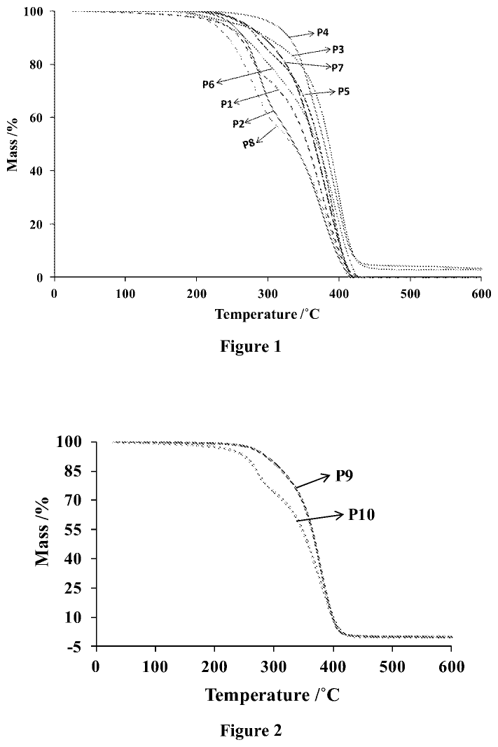

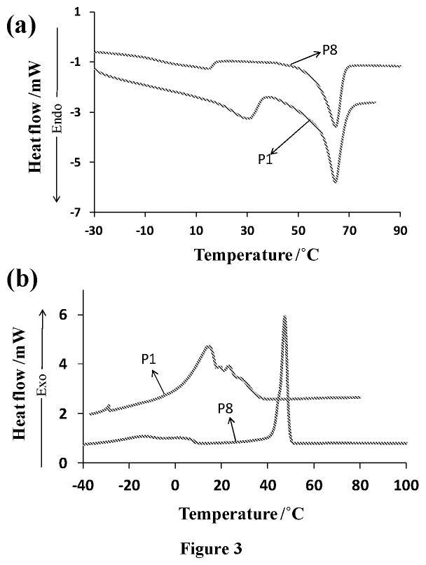

### DETAILED DESCRIPTION

Those skilled in the art will be aware that the present disclosure is subject to variations and modifications other than those specifically described. It is to be understood that the present disclosure includes all such variations and modifications. The disclosure also includes all such steps, features, compositions and compounds referred to or indicated in this specification, individually or collectively and any and all combinations of any or more of such steps or features.

### Definitions

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. Throughout this specification, unless the context requires otherwise the word “comprise”, and variations, such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The term “between” should be understood as being inclusive of the limits.

The term “dewaxing aid” is used to mean any chemical that assists in the propane dewaxing process by formation of uniform wax crystals and thereby improving filtration rates and dewaxed oil yields. Dewaxing Aids are high molecular weight polymeric compounds that act as seeds for the wax (paraffin) molecules. Since different refineries process different types of crudes and produce different grade cuts, the type of dewaxing aid (DWA) used by a refinery has to be customized according to its requirements. The DWA which works for low viscosity oils will not work for high viscosity oils.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

In view of the problems discussed in the Background section, the present disclosure provides dewaxing aid polymeric material that co-crystallises with the wax and helps to develop larger, more uniformly sized wax crystals that enable higher filtration rates due to the improved filtrate separation from the agglomerated crystals. Thus, the present disclosure provides a refined petroleum product with a higher yield in less time without significant capital investment, while maintaining the quality specifications, especially the pour points, of the petroleum produced.

In an embodiment of the present disclosure, there is provided a copolymer of Formula I, wherein:

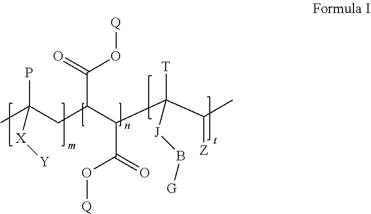

‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.
The structure of Formula I depicts the monomer repeating units that constitute the polymer. However, the monomers units are not arranged in essentially the same order as depicted in Figure I. The polymer can be an alternating, periodic, statistical or a block copolymer. Additionally, any end of the double bond of a certain monomer unit can be attached to any end of the double bond of the other monomer unit. For instance, a methacrylate unit can be attached to another monomer unit through either the methylene carbon of the double bond or the methine one. Same applies to other monomer units. Polymeric structures arising out of all such permutations and combinations are contemplated to fall within the scope of the instant disclosure.

In an embodiment of the present disclosure, there is provided a copolymer of Formula I, wherein: ‘P’ is selected from hydrogen and C₁₋₁₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₅ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is C₁ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is hydrogen; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is carbonyl (C═O); ‘Y’ is selected from —OC₁₋₂₀ alkyl and —C(O)C₁₋₂₀ alkyl; ‘Q’ is C₁₋₂₀ alkyl; T′ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₁₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₈ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₅ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₅ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is —OC₈ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is —OC₁ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₁₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₅ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is —C(O)C₁ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₁₈ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₁₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₈ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₅ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₈ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₈ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₁₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₅ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is C₁ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is hydrogen; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent; ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₁₈ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₁₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₈ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₅ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₄ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is C₁₈ alkyl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is C₈ alkyl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is C₄ alkyl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is —C(O)OC₁₋₁₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is —C(O)OC₁₋₈ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is —C(O)OC₁₋₅ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is —C(O)OC₈ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 5-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 10-400.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 20-300.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₁₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₅ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is C₁ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is hydrogen; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is carbonyl (C═O); ‘Y’ is selected from —OC₁₋₂₀ alkyl and —C(O)C₁₋₂₀ alkyl; ‘Q’ is C₁₋₂₀ alkyl; T′ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₁₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₈ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₅ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₈ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is —OC₈ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is —OC₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₁₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₅ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is —C(O)C₁ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₁₈ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₁₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₈ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₅ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is Cis alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₈ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₁₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₅ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is C₁ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is hydrogen; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent; ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₁₈ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₁₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₈ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₅ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₄ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is C₁₈ alkyl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is C₈ alkyl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is C₄ alkyl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is —C(O)OC₁₋₁₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is —C(O)OC₁₋₈ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is —C(O)OC₁₋₅ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is —C(O)OC₈ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 5-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 10-400.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 20-300.

In an embodiment of the present disclosure, there is provided a copolymer of Formula I, wherein: ‘P’ is C₁ alkyl; ‘X’ is selected from carbonyl (C═O); ‘Y’ is —OC₁ alkyl; ‘Q’ is C₁₈ alkyl; ‘T’ is C₁alkyl; ‘J’ is carbonyl (C═O); ‘B’ is ‘O’; ‘G’ is C₁₈ alkyl; ‘Z’ is hydrogen and ‘m’, ‘n’, and ‘t’ are in the range of 2-500.

In an embodiment of the present disclosure, there is provided a copolymer of Formula I, wherein: ‘P’ is C₁ alkyl; ‘X’ is selected from carbonyl (C═O); ‘Y’ is —OC₁ alkyl; ‘Q’ is C₈ alkyl; ‘T’ is C₁alkyl; ‘J’ is carbonyl (C═O); ‘B’ is ‘O’; ‘G’ is C₁₈ alkyl; ‘Z’ is hydrogen and ‘m’, ‘n’, and ‘t’ are in the range of 2-500.

In an embodiment of the present disclosure, there is provided a copolymer of Formula I, wherein: ‘P’ is C₁ alkyl; ‘X’ is selected from carbonyl (C═O); ‘Y’ is —OC₁ alkyl; ‘Q’ is C₁₈ alkyl; ‘T’ is hydrogen; ‘J’ is carbonyl (C═O); ‘B’ is ‘O’; ‘G’ is C₈ alkyl; ‘Z’ is hydrogen and ‘m’, ‘n’, and ‘t’ are in the range of 2-500.

In an embodiment of the present disclosure, there is provided a copolymer of Formula I, wherein: ‘P’ is C₁ alkyl; ‘X’ is selected from carbonyl (C═O); ‘Y’ is —OC₁ alkyl; ‘Q’ is C₁₈ alkyl; ‘T’ is hydrogen; ‘J’ is carbonyl (C═O); ‘B’ is ‘O’; ‘G’ is C₄ alkyl; ‘Z’ is hydrogen and ‘m’, ‘n’, and ‘t’ are in the range of 2-500.

In an embodiment of the present disclosure, there is provided a copolymer of Formula I, wherein: ‘P’ is C₁ alkyl; ‘X’ is selected from carbonyl (C═O); ‘Y’ is —OC₁ alkyl; ‘Q’ is C₁₈ alkyl; ‘T’ is hydrogen; ‘J’ is carbonyl (C═O); ‘B’ is ‘O’; ‘G’ is C₈ alkyl; ‘Z’ is —C(O)OC₈ alkyl and ‘m’, ‘n’, and ‘t’ are in the range of 2-500.

In an embodiment of the present disclosure, there is provided a copolymer of Formula I, wherein: ‘P’ is C₁ alkyl; ‘X’ is selected from carbonyl (C═O); ‘Y’ is —OC₁ alkyl; ‘Q’ is C₁₈ alkyl; ‘T’ is C₁alkyl; ‘J’ is carbonyl (C═O); ‘B’ is ‘O’; ‘G’ is C₆aryl isoptionally substituted with one or more of the groups selected from hydrogen, C₁₋₂₀ alkyl, C₁₋₂₀ alkenyl, C₁₋₂₀ alkynyl, C₇₋₂₀-alkylaryl; ‘Z’ is hydrogen and ‘m’, ‘n’, and ‘t’ are in the range of 2-500.

In an embodiment of the present disclosure, there is provided a copolymer of Formula I, wherein: ‘P’ is hydrogen; ‘X’ is selected from carbonyl (C═O); ‘Y’ is —C(O)C₁ alkyl; ‘Q’ is C₁₈ alkyl; ‘T’ is C₁ alkyl; ‘J’ is carbonyl (C═O); ‘B’ is ‘O’; ‘G’ is C₁₈ alkyl; ‘Z’ is hydrogen and ‘m’, ‘n’, and ‘t’ are in the range of 2-500.

In an embodiment of the present disclosure, there is provided a copolymer of Formula I, wherein: ‘P’ is C₁ alkyl; ‘X’ is selected from carbonyl (C═O); ‘Y’ is —C(O)C₈ alkyl; ‘Q’ is C₁₈ alkyl; ‘T’ is C₁ alkyl; ‘J’ is carbonyl (C═O); ‘B’ is ‘O’; ‘G’ is C₁₈ alkyl; ‘Z’ is hydrogen and ‘m’, ‘n’, and ‘t’ are in the range of 2-500.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500, and wherein the copolymer is selected from block copolymer, and random copolymer and combinations thereof.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500, and wherein the copolymer is selected from block copolymer, and random copolymer and combinations thereof.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500, and wherein the copolymer has a polydispersity index (PDI) in the range of 0.5-9.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500, and wherein the copolymer has a polydispersity index (PDI) in the range of 0.5-9.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500, and wherein the polymer has a weight average molecular weight (M_{w}) in the range of 1000-100000.

In an embodiment of the present disclosure, there is provided a copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500, and wherein the polymer has a weight average molecular weight (M_{w}) in the range of 1000-100000.

In an embodiment of the present disclosure, there is provided a process for preparation of copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500, and wherein, the copolymer is selected from block copolymer, and random copolymer and combinations thereof; the copolymer has a polydispersity index (PDI) in the range of 0.5-9; and the polymer has a weight average molecular weight (M_{w}) in the range of 1000-100000.

In an embodiment of the present disclosure, there is provided a process for preparation of copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl and ‘m’, ‘n’, and ‘t’ are in the range of 2-500 and wherein, the copolymer is selected from block copolymer, and random copolymer and combinations thereof; the copolymer has a polydispersity index (PDI) in the range of 0.5-9; and the polymer has a weight average molecular weight (M_{w}) in the range of 1000-100000.

In an embodiment of the present disclosure, there is provided a process for preparation of copolymer of Formula I comprising the steps of: (a) contacting at least one solvent, and at least one polymer of Formula I to obtain a first mixture; (b) contacting the first mixture, and at least one petroleum product, to obtain the second mixture; (c) filtering the second mixture through a filtering assembly to obtain a residue and a filtrate; (d) washing the residue and the filtrate with at least one solvent to obtain a washed residue and a filtrate with wash; and (e) processing the washed residue and filtrate with wash to obtain the dewaxed petroleum product.

In an embodiment of the present disclosure, there is provided a process for preparation of copolymer of Formula I comprising the steps of: (a) contacting at least one solvent, and at least one polymer of Formula I to obtain a first mixture; (b) contacting the first mixture, and at least one petroleum product, to obtain the second mixture; (c) filtering the second mixture through a filtering assembly to obtain a residue and a filtrate; (d) washing the residue and the filtrate with at least one solvent to obtain a washed residue and a filtrate with wash; and (e) processing the washed residue and filtrate with wash to obtain the dewaxed petroleum product, wherein the at least one petroleum product is raffinates of lube oil selected from the group consisting of spindle oil, 150 N, 500 N, bright stock, and combinations thereof.

In an embodiment of the present disclosure, there is provided a process for preparation of copolymer of Formula I comprising the steps of: (a) contacting at least one solvent, and at least one polymer of Formula I to obtain a first mixture; (b) contacting the first mixture, and at least one petroleum product, to obtain the second mixture; (c) filtering the second mixture through a filtering assembly to obtain a residue and a filtrate; (d) washing the residue and the filtrate with at least one solvent to obtain a washed residue and a filtrate with wash; and (e) processing the washed residue and filtrate with wash to obtain the dewaxed petroleum product, wherein the at least one solvent is selected from the group consisting methyl ethyl ketone (MEK), hexane, and combinations thereof.

In an embodiment of the present disclosure, there is provided a process for preparation of copolymer of Formula I comprising the steps of: (a) contacting at least one solvent, and at least one polymer of Formula I to obtain a first mixture; (b) contacting the first mixture, and at least one petroleum product, to obtain the second mixture; (c) filtering the second mixture through a filtering assembly to obtain a residue and a filtrate; (d) washing the residue and the filtrate with at least one solvent to obtain a washed residue and a filtrate with wash; and (e) processing the washed residue and filtrate with wash to obtain the dewaxed petroleum product, wherein (i) contacting at least one solvent, and at least one polymer of Formula I to obtain a first mixture is carried out at a temperature in the range of 20-35° C.; (ii) contacting the first mixture, and at least one petroleum product, to obtain the second mixture is carried out at a temperature in the range of 20-35° C. followed by heating the second mixture until a homogeneous second mixture is obtained; (iii) filtering the second mixture through a filtering assembly to obtain a residue and a filtrate at a pressure in the range of 180-240 mm of Hg; (iv) washing the residue and the filtrate with at least one solvent to obtain a washed residue and a filtrate with wash at a temperature in the range of −15° C. to −35° C.; and (v) processing the washed residue and filtrate with wash to obtain the dewaxed petroleum product is carried out by removal of solvent.

In an embodiment of the present disclosure, there is provided a use of copolymer of Formula I, wherein: ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl, and wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH and ‘m’, ‘n’, and ‘t’ are in the range of 2-500 and wherein, the copolymer is selected from block copolymer, and random copolymer and combinations thereof; the copolymer has a polydispersity index (PDI) in the range of 0.5-9; the polymer has a weight average molecular weight (M_{w}) in the range of 1000-100000; and the polymer is used as an additive in solvent dewaxing of petroleum products.

### EXAMPLES

The following examples are given by way of illustration of the present invention and should not be construed to limit the scope of present disclosure. It is to be understood that both the foregoing general description and the following detailed description are exemplary and explanatory only and are intended to provide further explanation of the claimed subject matter.

### Example 1 Process for Preparation of Copolymers (Dewaxing Aids)

P1. Poly(methyl methacrylate-co-dioctadecyl fumarate-co-octadecyl methacrylate) (PMMA-co-DODF-co-ODMA)

A mixture of methyl methacrylate (1.75 g, 33.3 wt %), octadecyl methacrylate (1.75 g, 33.3 wt %), dioctadecyl fumarate (1.75 g, 33.3 wt %), benzoyl peroxide (104 mg, 2 wt %) was taken in a round bottomed flask which was equipped with nitrogen inlet and outlet passages. The polymerization mixture was deoxygenated by passing nitrogen for 30 min. Subsequently, the flask was sealed and heated to 100° C. under stirring and allowed this condition for 10 h. After that, the polymerization was terminated by the addition of 0.5 mL of methanol and exposed to the air. The crude PMMA-co-DODF-co-ODMA in tetrahydrofuran (5 mL) was precipitated in methanol (200 mL) and isolated the polymer. The isolated polymer was re-dissolved in tetrahyrdofuran and re-precipitated in methanol. The isolated product was dried at 60° C. for 6 h. Yield: 90%. Characterization: FT-IR spectra showed characteristic bands at 1733 cm⁻¹ for P1 due to the stretching frequencies of ester carbonyl. The ester carbonyl stretching of the polymers shifted 11-28 cm⁻¹, i.e., towards higher wavenumber compared to the ester carbonyl of their corresponding monomers. The acrylic —C═C— signals (1629 and 1639 cm−1) of the monomers disappeared in the polymers FT-IR spectra. The ¹H-NMR spectra of the P1, tri-monomer copolymers showed coalesced signals centered at δ 4.05, 3.93 and 3.6 ppm due to the —O—CH2-methylene protons and broad and coalesced signals were observed at δ 0.80-2.35 ppm for both the polymers due to the pendant methylene spacer and macromolecular back bone methylene and methine protons of the polymer chain

P2. Poly(methyl methacrylate-co-dioctyl fumarate-co-octadecyl methacrylate) (PMMA-co-DOF-co-ODMA):

Methyl methacrylate (1.75 g, 33.3 wt %), octadecyl methacrylate (1.75 g, 33.3 wt %), dioctyl fumarate (1.75 g, 33.3 wt %), benzoyl peroxide (104 mg, 2 wt %) mixture was taken in a polymerization flask which was equipped with nitrogen in and out way passages. This mixture was deoxygenated by passing nitrogen for 30 min. Then, the flask was sealed and heated to 100° C. under stirring and allowed this condition for 10 h. Then, the polymerization was stopped by the addition of 0.5 mL of methanol and exposed to the air. The solution of PMMA-co-DOF-co-ODMA was precipitated in methanol and isolated polymer. The isolated polymer was redissolved in THF and re-precipitated in methanol. The isolated product was dried at 60° C. for 6 h. Yield: 85%. Characterization: FT-IR spectra showed characteristic bands at 1739 cm−1 for P2 due to the stretching frequencies of ester carbonyl. The ester carbonyl stretching of the polymers shifted 11-28 cm⁻¹, i.e., towards higher wavenumber compared to the ester carbonyl of their corresponding monomers. The acrylic —C═C— signals (1629 and 1639 cm⁻¹) of the monomers disappeared in the polymers FT-IR spectra. The 1H-NMR spectra of the P2, tri-monomer copolymers showed coalesced signals centered at δ 4.02, 3.9 and 3.5 ppm due to the —O—CH2-methylene protons and broad and coalesced signals were observed at δ 0.80-2.35 ppm for both the polymers due to the pendant methylene spacer and macromolecular back bone methylene and methine protons of the polymer chain.

P3. Poly(methyl methacrylate-co-dioctadecyl fumarate-co-2-ethylhexyl acrylate) (PMMA-co-DODF-co-2-EHA):

In this polymerization, we employed monomers and initiator in two feedings. In first step, a mixture of dioctadecyl fumarate (3 g, 33.3 wt %) and 2-ethylhexyl acrylate (3 g, 33.3 wt %) was taken in a three necked RB which was purged with continuous supply of N2 gas using in and outlets for 20 min. Then, benzoyl peroxide (120 mg, 2 wt % in DMF) solution was injected to the reaction mixture. The flask was dipped into an oil bath which was at 150° C. and this mixture was allowed under mechanical stirring for 3 h. Hereafter, the temperature of the polymerization was reduced to 100° C. In the second step, methyl methacrylate (3 g, 33.3 wt %) and benzoyl peroxide (60 mg, 2 wt %, in DMF) solution was injected to the reaction mixture and stirring continued for another 4 h. Then, the polymerization was terminated by the drop wise addition of 0.5 mL of methanol and exposed to the air. The polymerization solution was poured in to methanol and filtered the precipitation. The isolated polymer was dissolved in tetrahydrofuran and re-precipitated in methanol. The product was isolated and dried at 60° C. for 6 h. Yield: 85%. Characterization: FT-IR spectra showed characteristic bands at 1735 cm−1 for P3 due to the stretching frequencies of ester carbonyl. The ester carbonyl stretching of the polymers shifted 11-28 cm⁻¹, i.e., towards higher wavenumber compared to the ester carbonyl of their corresponding monomers. The acrylic —C═C— signals (1629 and 1639 cm⁻¹) of the monomers disappeared in the polymers FT-IR spectra. The 1H-NMR spectra of the P3, tri-monomer copolymers showed coalesced signals centered at δ 4.01, 3.90 and 3.60 ppm due to the —O—CH2-methylene protons and broad and coalesced signals were observed at δ 0.80-2.35 ppm for both the polymers due to the pendant methylene spacer and macromolecular back bone methylene and methine protons of the polymer chain.

P4. Poly(methyl methacrylate-co-dioctadecyl fumarate-co-butyl acrylate) (PMMA-co-DODF-co-BA):

Three necked RB which was equipped with continuous supply of N2 gas in and out lets were fixed and at first stage, dioctadecyl fumarate (4.5 g, 50 wt %), butyl acrylate (3 g, 33.3 wt %), and methyl methacrylate (3 g, 33.3 wt %) mixture was taken with constant purging of N2 gas for 20 min. Later, benzoyl peroxide (210 mg, 2 wt %, in DMF) solution was injected into the polymerization mixture. The flask was dipped into an oil bath which oil temperature was at 100° C. and this mixture was allowed under mechanical stirring for 3 h. At second stage, a mixture of dioctadecyl fumarate (4.5 g, 50 wt %), butyl acrylate (3 g, 33.3 wt %) and methyl methacrylate (3 g, 33.3 wt %) was added and subsequently, benzoyl peroxide (210 mg, 2 wt % in DMF) solution was added to the reactor and stirring was continued for another 3 h. At third stage, the monomers, butyl acrylate (3 g, 33.3 wt %) and methyl methacrylate (3 g, 33.3 wt %) were added followed by benzoyl peroxide (120 mg, 2 wt % in DMF) solution was injected. The polymerization mixture was stirred for another 3 h. Later, the polymerization was terminated by the drop wise addition of 1 mL of methanol and exposed to the air. The product was purified two times by reprecipitation in methanol. Yield: 89%. Characterization: FT-IR spectra showed characteristic bands at 1736 cm⁻¹ for P4 due to the stretching frequencies of ester carbonyl. The ¹H-NMR spectra of the P4, tri-monomer copolymers showed coalesced signals centered at δ 4.01 and 3.60 ppm due to the —O—CH₂-methylene protons and broad and coalesced signals were observed at δ 0.80-2.3 ppm for both the polymers due to the pendant methylene spacer and macromolecular back bone methylene and methine protons of the polymer chain.

P5. Poly(methyl methacrylate-co-dioctadecyl fumarate-co-dioctyl fumarate) (PMMA-coDODF-co-DOF):

A mixture of methyl methacrylate (4 g, 33.3 wt %), dioctyl fumarate (4 g, 33.3 wt %), dioctadecyl fumarate (4 g, 33.3 wt %) and benzoyl peroxide (240 mg, 2 wt % in DMF) was taken in three necked RB which was equipped with continuous supply of N2 gas. The flask was dipped into an oil bath which was at 135° C. and allowed under mechanical stirring for 10 h. After 5 h, initiator (120 mg in DMF) was injected. Then, the polymerization was terminated by the addition of 0.5 mL of methanol and exposed to the air, after 5 h. The product was purified by reprecipitation process in methanol. Yield: 50%. Characterization: FT-IR spectra showed characteristic bands at 1738 cm⁻¹ and 1704 for P5 due to the stretching frequencies of two ester carbonyl. The acrylic —C═C— signals (1629 and 1639 cm−1) of the monomers disappeared in the polymers FT-IR spectra. The ¹H-NMR spectra of the P5, tri-monomer copolymers showed coalesced signals centered at δ 4.1 and 3.60 ppm due to the —O—CH₂-methylene protons and broad and coalesced signals were observed at δ 0.80-2.32 ppm for both the polymers due to the pendant methylene spacer and macromolecular back bone methylene and methine protons of the polymer chain.

P6. Poly(methyl methacrylate-co-dioctadecyl fumarate-co-cardanyl methacrylate) (PMMA-co-DODF-co-CMA):

Methyl methacrylate (1.5 g, 33.3 wt %), cardanyl methacrylate (1.5 g, 33.3 wt %), dioctadecyl fumarate (1.5 g, 33.3 wt %) and benzoyl peroxide (90 mg, 2 wt %) mixture was taken in round bottomed flask which was equipped with N2 gas in and out let passages. This mixture was deoxygenated by passing N2 for 30 min. Then, the flask was sealed and heated to 90° C. under stirring and allowed this condition for 6 h. After that, the polymerization was terminated by the addition of 0.5 mL of methanol and exposed to the air. The polymerization mixture was poured into methanol and isolated polymer. The collected polymer was dissolved in tetrahydrofuran and precipitated in methanol. After filtration, the obtained polymer was dried at 60° C. for 6 h. Yield: 85%. Spectral characterization: FT-IR spectra showed characteristic bands at 1738 cm⁻¹ and 1704 for P6 due to the stretching frequencies of two ester carbonyl. The ester carbonyl stretching of the polymers shifted 11-28 cm⁻¹, i.e., towards higher wavenumber compared to the ester carbonyl of their corresponding monomers. The ¹H-NMR spectra of the P6, tri-monomer copolymers showed coalesced signals centered at δ 3.60 ppm due to the —O—CH₂-methylene protons and cardonyl R group (CH═CH) signal at 5.5 ppm is observed and broad and coalesced signals were observed at δ 0.50-2.35 ppm for both the polymers due to the pendant methylene spacer and macromolecular back bone methylene and methine protons of the polymer chain.

P7. Poly(vinyl acetate-co-dioctadecyl fumarate-co-octadecyl methacrylate) (PVA-co-DODF-co-ODMA):

In a round bottomed flask, vinyl acetate (0.5 g, 10 wt %), octadecyl methacrylate (3.5 g, 70 wt %), dioctadecyl fumarate (1 g, 20 wt %), toluene (20 mL) and benzoyl peroxide (150 mg, 3 wt % in DMF) was taken which was equipped with in and out let N2 gas passages. This mixture was deoxygenated by passing N2 gas for 30 min. Then, the flask was sealed and heated to 70° C. under stirring and allowed this condition for 6 h. Later, the polymerization was terminated by the addition of 0.5 mL of methanol and exposed to the air. The product was purified by reprecipitation process in methanol. Yield: 62%. Characterization: FT-IR spectra showed characteristic bands at 1729 cm⁻¹ for P7 due to the stretching frequencies of ester carbonyl. The ¹H-NMR spectra of the P7, tri-monomer copolymers showed coalesced signals centered at δ 4.01 due to the —O—CH₂-methylene protons and broad and coalesced signals were observed at δ 0.80-2.35 ppm.

P8. Poly(octyl methacrylate-co-dioctadecyl fumarate-co-octadecyl methacrylate) (POMA-co-DODF-co-ODMA)

A mixture of octyl methacrylate (2.5 g, 50 wt %), octadecyl methacrylate (1.5 g, 30 wt %), dioctadecyl fumarate (1 g, 20 wt %) and benzoyl peroxide (50 mg, 1 wt % in DMF) and AIBN (50 mg, 1 wt % in DMF) was taken in round bottomed flask under N₂ blanket. This mixture was deoxygenated by passing N₂ gas for 30 min. Then, the flask was sealed and heated to 150° C. under stirring and allowed this condition for 6 h. After the period, the polymerization was terminated by the addition of 0.5 mL of methanol and exposed to the air. The product was purified by re-precipitation process in methanol and dried resulted polymer at 60° C. for 6 h. Yield: 88%. Characterization: FT-IR spectra showed characteristic bands at 1730 cm⁻¹ and 1706 for P8 due to the stretching frequencies of two ester carbonyl for P8 due to the stretching frequencies of ester carbonyl. The ester carbonyl stretching of the polymers shifted 11-28 cm⁻¹, i.e., towards higher wavenumber compared to the ester carbonyl of their corresponding monomers. The ¹H-NMR spectra of the P3, tri-monomer copolymers showed coalesced signals centered at δ 3.9 ppm due to the —O—CH2-methylene protons and broad and coalesced signals were observed at δ 0.80-2.35 ppm for both the polymers due to the pendant methylene spacer and macromolecular back bone methylene and methine protons of the polymer chain

Poly (Methyl methacrylate-co-Dioctadecyl fumarate-co-2-Ethylhexyl acrylate) (PMMA-co-DODF-co-2-EHA) [P9 (batch size: 5 Lit of P3)]:

Three necked RB which was equipped with continuous supply of N2 gas with in and out lets N2 was purged for about 30 min before adding the monomers. Here we employed monomers and initiator in three feeds. In feed-I, a mixture of dioctadecyl fumarate (250 g, 50 wt %), 2-ethylhexyl acrylate (188.3 ml, 33.3 wt %), methyl methacrylate (177.3 ml, 33.3 wt %) along with 100 ml of toluene was taken and this was purged with N₂ gas for 30 min. After this benzoyl peroxide (11.67 g, 2 wt %) in 79.7 ml toluene solution was injected to the reaction mixture. The flask was dipped into an oil bath which was at 100° C. and this mixture was allowed under mechanical stirring for 3 h. In feed-II a mixture of dioctadecyl fumarate (250 g, 50 wt %), 2-ethylhexyl acrylate (188.3 ml, 33.3 wt %), methyl methacrylate (177.3 ml, 33.3 wt %) along with 100 ml of toluene and subsequently benzoyl peroxide (11.67 g, 2 wt %) in 79.7 ml toluene solution was added to the reactor and stirring continued for another 3 h. Then, in feed-III, monomers 2-ethylhexyl acrylate (188.3 ml, 33.3 wt %) and methyl methacrylate (177.3 ml, 33.3 wt %) were added and subsequently, benzoyl peroxide (6.67 g, 2 wt %) in 45.4 ml toluene was injected and stirring continued for another 2 h. Temperature of the reactor was increased to 120° C. and benzoyl peroxide (6.6 g) in 45.4 ml toluene was injected and the stirring was continued for another 1 h. After the period, the polymerization was stopped by the drop wise addition of 15 mL of methanol and stirred about 30 min. Then the toluene was evaporated under vacuum at 50° C. to get PMMA-co-DODF-co-2EHA co-polymer.

Poly (Methyl methacrylate-co-Dioctadecyl fumarate-co-2-Ethylhexyl acrylate) (PMMA-co-DODF-co-ODMA) [P10 (P1 batch size: 5 Lit]

Three necked RB which was equipped with continuous supply of N2 gas with in and out lets N2 was purged for about 30 min before adding the monomers. Here we employed monomers and initiator in three feeds. In feed-I, a mixture of dioctadecyl fumarate (500 g, 100 wt %), octadecyl methacrylate (333.2 g, 66.6 wt %), methyl methacrylate (354.6 ml, 66.6 wt %) along with 200 ml of toluene was taken and this was purged with N2 gas for 30 min. After this benzoyl peroxide (11.67 g, 2 wt %) in 159.4 ml toluene solution was injected to the reaction mixture. The flask was dipped into an oil bath which was at 100° C. and this mixture was allowed under mechanical stirring for 4 h. In feed-II, a mixture of octadecyl methacrylate (166.6 g, 33.3 wt %), and methyl methacrylate (177.3 ml, 33.3 wt %) along with 100 ml of toluene and subsequently benzoyl peroxide (6.67 g, 2 wt %) in 45.4 ml toluene solution was added to the reactor and stirring continued for another 2 h. Then, temperature of the reactor was increased to 120° C. and subsequently, benzoyl peroxide (6.6 g, 2 wt %) in 45.4 ml toluene was injected and stirring continued for another 1 h. After the period, the polymerization was stopped by the drop wise addition of 15 mL of methanol and stirred about 30 min. Then the toluene was evaporated under vacuum at 50° C. to get PMMA-co-DODF-co-ODMA.

### Example 2

### General Methods:

Fourier Transform Infrared Spectroscopy (FTIR) The absorption spectra in the infrared region for the samples, within the range of 4000 cm⁻¹ to 650 cm⁻¹, were obtained in a FT-IR Thermo Nicolet Nexus 670 spectrometer, spectra were recorded at a resolution of 4 cm⁻¹ using KBr optics at room temperature and a minimum of 32 scans were single averaged. The spectra were obtained at (27±2° C.) with the sample added directly into the device, with no prior treatment.

Size exclusion Chromatography (SEC): The MW was characterized by size exclusion chromatography, and the results are recorded in Table 1.

Thermogravimetry (TG) The TG analysis was performed to verify the mass variation with increasing temperature, the thermal stability, and the thermal degradation temperature of the 5% w/w and 10% w/w of the synthesized polymer samples. Using a TGA Q-500 thermal analyser, the test was conducted at a heating ratio of 10° C.·min⁻¹, from room temperature (27±2° C.) up to 600° C., in a platinum sample holder and in a nitrogen atmosphere (N2), at a flow rate of 50 mL·min⁻¹. The values of these temperatures are summarized in Table 1 and represented in FIG. 13.

Differential Scanning Calorimetry (DSC) The DSC equipment (DSC Q100) The sample was, first equilibrated to −40° C. and heated (first heating) from −40° C. to 200° C. at 10° C. min⁻¹ and then it was cooled (first cooling) from 200° C. to −40° C. at a rate of 10° C. min⁻¹ using TA, Refrigerated Cooling System 90. Then the sample was again heated (second heating) from −40° C. to 200° C. at a rate of 10° C.·min⁻¹ and subsequently it was cooled (cooling) from 200° C. to −40° C. at a rate of 10° C.·min⁻¹. The second heating and cooling curves were reported.

TABLE 1
Copolymers molecular weight and thermal properties

| Dewaxing | SEC^{a} | | TGA^{b} | | DSC^{c} | |
|---|---|---|---|---|---|---|
| Aid | M_{w} | PDI | T_{d5%} | T_{d10%} | T_{m/° C.} | T_{c/° C.} |
| P1 | 42854 | 2.16 | 237 | 261 | 64 | 14 |
| P2 | _d | — | 250 | 266 | 89 | 68 |
| P3 | 54426 | 1.48 | 258 | 297 | 28 | 16 |
| P4 | 61501 | 5.78 | 309 | 330 | 31 | 26 |
| P5 | 8328 | 1.03 | 266 | 285 | 69 | 58 |
| P6 | 66490 | 3.8 | 238 | 269 | 69 | 49 |
| P7 | 80617 | 1.04 | 268 | 293 | 36 | 27 |
| P8 | 18368 | 2.45 | 223 | 243 | 65 | 48 |

^{a}THF used as an eluent at room temperature'
^{b}temperature of 5 and 10 weight percent of sample thermal degradation under nitrogen,
^{c}from DSC curve on second heating'
^{d}not determined

### Example 3

### General Process for Dewaxing Petroleum Product:

Filtration test: In 1 liter beaker, 375 mL of methyl ethyl ketone (MEK)/Hexane (1:1) solution, required quantity of dewaxing aid (DWA) was added and mixed well to obtain the first mixture. To this first mixture 125 ml of feed sample* (feed to solvent ratio is 1:3) was added. The mixture was stirred thoroughly and was heated to form a homogeneous solution. Further, the solution was cooled gradually to −30° C. at a rate of 2 to 3° C./min to obtain the second mixture.

Furthermore, the second mixture was filtered at 200 mm Hg abs. pressure through a filtration assembly consisting of a filter stick with plant filter cloth, a graduated cylinder and vacuum balancing device to obtain a residue and filtrate. The time taken for various volumes of filtrate was recorded. After filtration is complete wash the cake with 125 mL of MEK/Hexane (1:1) solution at −30° C. The residue wash and the filtrate with wash was collected and the finally the solvent was stripped from the residue wash and the filtrate wash to obtain the dewaxed petroleum product. The dewaxed petroleum product was further tested on the following parameters (a) % of dewaxing aid (DWA) used (b) yield of the dewaxed oil; (c) cloud point; (d) pour point; (e) density at 40° C./g/cm³; (f) kinematic viscosity/mm²/s of DWO at 40° C./100° C.; and (g) viscosity index, and the results obtained are recorded in Table 3, Table 4, and Table 5.

TABLE 3
Extracted oil yield by employing 0.1 weight % dewaxing aid and extracted oil
characteristics

| | | | | | | | Kinematic | | |
|---|---|---|---|---|---|---|---|---|---|
| | | Extracted | | Cloud | Pour | Density | viscosity/mm²/s | | |
| Dewaxing | | oil yield | | point/ | point/ | at 40 | At | At | Viscosity |
| Aid | Dose/wt % | mL | % | ° C. | ° C. | ° C./g/cm ³ | 40° C. | 100° C. | Index |
| P1 | 0.1 weight % | 85 | 68 | −10 | −18 | — | 107 | 11.53 | 97 |
| P2 (SS-RL-45) | 0.1 weight % | 83 | 66.4 | −1 | −18 | — | 95.04 | 10.88 | 98 |
| P3 | 0.1 weight % | 92 | 73.6 | +1 | −15 | — | 101.57 | 11.12 | 98 |
| P4 | 0.1 weight % | 87 | 69.6 | 0 | 0 | — | 99.81 | 10.88 | 92 |
| P5 | 0.1 weight % | 87 | 69.6 | +2 | +1 | — | — | — | — |
| P6 | 0.1 weight % | 76 | 60.8 | +4 | +3 | — | — | — | — |
| P7 | 0.1 weight % | 69 | 55.2 | +4 | +3 | 0.8796 | 101.42 | 11.278 | 96.7 |
| P8 | 0.1 weight % | 79 | 60.8 | +9 | +6 | — | — | — | — |

TABLE 4
Extracted oil yield by employing 5 L scaled up batch copolymer and extracted
oil characteristics

| | | | | | | Kinematic | | |
|---|---|---|---|---|---|---|---|---|
| | | | | | | viscosity/mm²/s | | |
| | | Extracted | | Cloud | Pour | (KV) | | |
| Dewaxing | | oil yield | | point/ | point/ | At | At | Viscosity |
| Aid | Dose/wt % | mL | % | ° C. | ° C. | 40° C. | 100° C. | Index |
| P9C | 0.2 | 87.5 | 70 | −2 | −15 | 96.6 | 10.88 | 96 |
| P9 P | 0.2 | 77 | 61.6 | 0 | −18 | 105.7 | 11.36 | 95 |
| P9 C | 0.1 | 87 | 69.6 | −6 | −6 | 105 | 11.34 | 95 |
| P9 P | 0.1 | 76 | 60.8 | 1 | −12 | 105.09 | 10.77 | 96 |
| P9 C | 0.05 | 101 | 80.8 | −1 | −3 | 100.82 | 10.97 | 96 |
| P9 P | 0.05 | 88 | 71.0 | −1 | −10 | 98.14 | 10.72 | 97 |
| P9 C | 0.02 | 89 | 71.2 | 10 | −15 | 94.85 | 10.72 | 96 |
| P9 P | 0.02 | 91 | 72.8 | 0 | 8 | 100.2 | 10.9 | 92 |
| P9 C | 0.01 | 88 | 70.4 | 3 | −9 | 100.55 | 10.96 | 92 |
| P9 P | 0.01 | 76 | 60.8 | −2 | −3 | 105.57 | 11.11 | 90 |
| P9 C | 0.1 | 92 | 73.6 | −6 | −10 | 104.23 | 11.14 | 91 |
| P9 C | 0.05 | 91 | 72.8 | −1 | −5 | 100.82 | 10.97 | 92 |

TABLE 5
Extracted oil yield by employing 5 L scaled up batch copolymer and extracted
oil characteristics

| | | Extracted | | | | Kinematic | | |
|---|---|---|---|---|---|---|---|---|
| | Dose/ | oil yield | | Cloud point/ | Pour point | viscosity/mm²/s | | Viscosity |
| Dewaxing Aid | wt % | mL | % | ° C. | ° C. | At 40° C. | At 100° C. | Index |
| P10 C | 0.2 | 89 | 71.2 | −8 | −18 | 104.68 | 11.25 | 95 |
| P10 C | 0.1 | 96 | 76.8 | −8 | −9 | 105.2 | 11.18 | 94 |
| P10 C | 0.05 | 89 | 71.2 | −2 | −3 | 102.6 | 11.07 | 92 |
| P10 C | 0.02 | 90 | 72 | −5 | −6 | 102.1 | 11.02 | 92 |
| P10 C | 0.01 | 83 | 66.4 | −1 | −3 | 102.38 | 11.26 | 92 |
| P10P | 0.2 | 75 | 60 | −1 | −21 | 105.7 | 11.36 | 94 |
| P10 P | 0.1 | 96 | 76.8 | −8 | −9 | 105.2 | 11.18 | 92 |
| P10P | 0.05 | 89 | 71.2 | −2 | −8 | 102.6 | 11.07 | 92 |
| P10P | 0.02 | 90 | 72 | −5 | −6 | 102.1 | 11.02 | 93 |
| P10 P | 0.01 | 83 | 66.4 | −1 | −3 | 86.38 | 10.26 | 99 |
| P10 C | 0.05 | 92 | 73.2 | −2 | −5 | 102.6 | 11.07 | 92 |

TABLE 6
Comparison of P9 with commercial sample

| Sample | | | | | Comm | | | Comm |
|---|---|---|---|---|---|---|---|---|
| Names | P9 | P9 | P9 | P9 | 1 | Comm1 | Comm1 | 1 |
| DWA | 500N- | 500N- | 150N- | 150N- | 500N- | 500N- | 150N- | 150N- |
| | 0.1% | 0.05% | 0.05% | 0.1% | 0.05% | 0.1% | 0.05% | 0.1% |
| Dosage of | 0.10% | 0.05% | 0.05% | 0.10% | 0.05% | 0.10% | 0.05% | 0.10% |
| additive | | | | | | | | |
| (%) | | | | | | | | |
| Yield (ml) | 87 | 80 | 85 | 93 | 80 | 85 | 85 | 83 |
| Yield (%) | 69 | 64 | 68 | 74.4 | 64 | 68 | 68 | 67 |
| Cloud point | −6 | −5 | −5 | −9 | −4 | −10 | −1 | −8 |
| (° C.) | | | | | | | | |
| Pour point (° C.) | −12 | −6 | −7 | −12 | −6 | −15 | −5 | −12 |
| KV @40° C. | 87.39 | 91.45 | 29.009 | 28.588 | 104.01 | 100.53 | 29.259 | 25.978 |
| (mm²/s) | | | | | | | | |
| KV@100° C. | 10.18 | 10.41 | 4.9662 | 4.9692 | 11.05 | 10.77 | 5.0017 | 4.618 |
| (mm²/s) | | | | | | | | |
| VI | 97 | 96 | 94 | 97 | 90 | 89 | 94 | 88 |

One way to characterize the effects of a dewaxing aid on the treated oil was to upon the calculate the viscosity index or VI (Table 3, 4, 5 and 6). The viscosity index is an arbitrary empirical number indicating the degree of change in viscosity of an oil within a given temperature range. It is determined by measuring the kinematic viscosities of the oil at 40° C. and 100° C. and then comparing these to reference fluid viscosities at the same two temperatures. A high viscosity index indicates a relatively small change of viscosity with temperature and vice versa.

It is clear from the above Tables 2, 3, 4, 5 and 6 that the use of the copolymers as dewaxing aid as an additive (0.2 to 2 weight %) for solvent dewaxing of the wax containing petroleum products, enhances the rate of filtration of wax from propane, raffinate, and lube oils, additionally improves the dewaxed oil yield (60 to 83%) and required oil density (0.87-0.88 g/cm³ at 40° C.) cloud point (0 to −5° C.); pour point (0 to −20° C.); and viscosity index (94 to 96). Table 6 depicts data obtained from experiments, wherein dewaxing capacity of the polymers of the instant disclosure was compared with that of commercially available polymer. Comm 1 is a leading market product used for dewaxing purpose. As can be inferred from the data in Table 6, on almost all counts, the polymer of instant disclosure scored at least as much as Comm 1, and in some cases, did better than Comm 1.

Overall, the instant disclosure discloses a ter-polymer which exhibits excellent dewaxing ability. The polymer when used for dewaxing yields dewaxed oil which displays all the desirable characteristics like low cloud point, pour point, and kinematic viscosity.

1. A copolymer of Formula I: 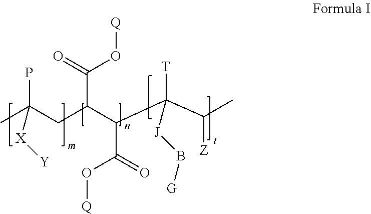
wherein ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl,
wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, C₇₋₂₀-alkylaryl, oxo (═O), C₃₋₈ cycloalkyl, halogen, OH;
‘m’, ‘n’, and ‘t’ are in the range of 2-500.

2. A copolymer of Formula I: 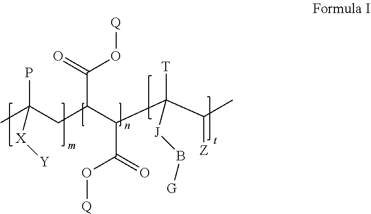
wherein ‘P’ is selected from hydrogen and C₁₋₂₀ alkyl; ‘X’ is selected from carbonyl (C═O) and ‘O’; ‘Y’ is selected from —OC₁₋₂₀ alkyl and —C(O)C₁₋₂₀ alkyl; ‘Q’ is C₁₋₂₀ alkyl; ‘T’ is selected from the group consisting of hydrogen, C₁₋₂₀ alkyl, and —C(O)OC₁₋₂₀ alkyl; ‘J’ is absent or carbonyl (C═O); ‘B’ is absent or ‘O’; ‘G’ is absent or selected from C₁₋₂₀ alkyl and C₅₋₆ aryl; ‘Z’ is absent or —C(O)OC₁₋₂₀ alkyl,
wherein C₁₋₂₀ alkyl, —OC₁₋₂₀ alkyl, —C(O)C₁₋₂₀ alkyl, —C(O)OC₁₋₂₀ alkyl, C₅₋₆ aryl is optionally substituted with one or more of the groups selected from hydrogen, C₁₋₂₀ alkyl, C₁₋₂₀ alkenyl, C₁₋₂₀ alkynyl, and C₇₋₂₀-alkylaryl;
‘m’, ‘n’, and ‘t’ are in the range of 2-500.

3. The polymer as claimed in any of the claims 1 or 2, wherein the copolymer is selected from block copolymer and random copolymer.

4. The polymer as claimed in any of the claims 1 or 2 having polydispersity index (PDI) in the range of 0.5-9.

5. The polymer as claimed in any of the claims 1 or 2 having weight average molecular weight (Mw) in the range of 1000-100000.

6. A process for the preparation of polymer as claimed in any of the claims 1 or 2.

7. A process for dewaxing petroleum product, comprising the steps of: (a) contacting at least one solvent, and at least one polymer as claimed in any of the claims 1 or 2 to obtain a first mixture; (b) contacting the first mixture, and at least one petroleum product, to obtain the second mixture; (c) filtering the second mixture through a filtering assembly to obtain a residue and a filtrate; (d) washing the residue and the filtrate with at least one solvent to obtain a washed residue and a filtrate with wash; and (e) processing the washed residue and filtrate with wash to obtain the dewaxed petroleum product.

8. The process as claimed in claim 7, wherein the at least one petroleum product is raffinates of lube oil selected from the group consisting of spindle oil, 150 N, 500 N, bright stock, and combinations thereof.

9. The process as claimed in claim 7, wherein the at least one solvent is selected from the group consisting methyl ethyl ketone (MEK), hexane, and combinations thereof.

10. The process as claimed in claim 7, wherein (a) contacting at least one solvent, and at least one polymer to obtain a first mixture is carried out at a temperature in the range of 20-35° C.; (b) contacting the first mixture, and at least one petroleum product, to obtain the second mixture is carried out at a temperature in the range of 20-35° C. followed by heating the second mixture until a homogeneous second mixture is obtained; (c) filtering the second mixture through a filtering assembly to obtain a residue and a filtrate at a pressure in the range of 180-240 mm of Hg; (d) washing the residue and the filtrate with at least one solvent to obtain a a washed residue and a filtrate with wash at a temperature in the range of −15° C. to −35° C.; and (e) processing the washed residue and filtrate with wash to obtain the dewaxed petroleum product is carried out by removal of solvent.

11. Use of the polymer as claimed in any of the claims 1 or 2 as an additive in solvent dewaxing of petroleum products.
